(19) United States
(12) Patent Application Publication
(10) Pub. No.: US 2024/0126805 A1
(43) Pub. Date: Apr. 18, 2024

(54) PROFILE-BASED DYNAMIC PRESENTATION

(71) Applicant: INTERNATIONAL BUSINESS MACHINES CORPORATION, ARMONK, NY (US)

(72) Inventors: Xinlin Wang, Irvine, CA (US); Tsz S. Cheng, Grand Prairie, TX (US); Tassanee Kraipon Supakkul, Tarrant, TX (US)

(21) Appl. No.: 18/046,528

(22) Filed: Oct. 14, 2022

(51) Int. Cl. G06F 16/438; G06F 16/435; H04L 12/18

(52) U.S. Cl. CPC G06F 16/4393; G06F 16/435; H04L 12/1822

(57) ABSTRACT

Method, computer program product, and computer system are provided. A content generation service receives a request to generate a presentation for an online meeting having attendees comprising different roles. The content generation service receives content for a generic presentation. One or more portion of a page or an entire page of the generic presentation is defined as customizable. Labels are assigned to each of the customizable portions of the generic presentation. Each label is associated with a role of an attendee in the online meeting. Customized content is received for each customizable portion. The customized content is associated with the label of the customizable portion. The generated presentation is stored separately in content object storage, as is each associated customized content.

### BACKGROUND

The present invention relates to computer systems, and more specifically to profile-bases dynamic presentations.

In a presentation, either in-person or virtual, a presenter typically can only share the same set of slides with all audiences via physical or virtual screens. However, the audiences may have different job roles, backgrounds, or may even speak different languages.

It would be advantageous to maintain one set of slides with intra-slide versioning that can be shared automatically during a presentation, based on individual audience profiles.

### SUMMARY

A method is provided. A content generation service receives a request to generate a presentation for an online meeting having attendees comprising different roles. The content generation service receives content for a generic presentation. One or more portion of a page or an entire page of the generic presentation is defined as customizable. Labels are assigned to each of the customizable portions of the generic presentation. Each label is associated with a role of an attendee in the online meeting. Customized content is received for each customizable portion. The customized content is associated with the label of the customizable portion. The generated presentation is stored separately in content object storage, as is each associated customized content.

Embodiments are further directed to computer systems and computer program products having substantially the same features as the above-described computer-implemented method.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates the operating environment of a computer server, according to an embodiment of the present invention;

FIG. 2 illustrates an exemplary architecture of a user profile-based content generation service, in accordance with one or more aspects of the present invention;

FIG. 3 illustrates a presenter's console in managing/editing mode, in accordance with one or more aspects of the present invention;

FIG. 4 illustrates an exemplary presentation during a live meeting, in accordance with one or more aspects of the present invention;

FIGS. 5A-5C illustrates exemplary customized contents, in accordance with one or more aspects of the present invention;

FIG. 6 illustrates a process flow for generating original content, in accordance with one or more aspects of the present invention;

FIG. 7 illustrates a process flow of a static generation service for static generation of child versions, in accordance with one or more aspects of the present invention;

FIG. 8 illustrates a process flow of a dynamic generation service for dynamic generation of child versions, in accordance with one or more aspects of the present invention; and

FIG. 9 illustrates a process flow for publishing content during an online meeting, in accordance with one or more aspects of the present invention.

### DETAILED DESCRIPTION

During an online meeting (e.g., Webex®, Zoom®), the presenter can only share the same version of the presentation, regardless of the makeup of the audience. This is a limitation of the meeting software. However, this uniform approach may not be effective, since the audiences may include different job roles (e.g., executives vs. engineers), backgrounds (e.g., technical vs. non-technical) or may even speak different languages (e.g., English vs. Spanish). Of course, the presenter's goal is to deliver a presentation that educational and informative. One way to achieve this goal is to manually prepare several different versions of the presentation, based on knowing the composition of the audience. However, this would require the presenter to review, analyze, and categorize the participants, based on the list of registrants. From that information, the presenter can either tailor a different presentation version for each category of participant or generate one presentation tailored to the average participant. Either case imposes an additional burden on the presenter to generate accurate and meaningful content, while minimizing errors. (Webex is a registered trademark of Cisco Systems in the United States and certain other countries, Zoom and the Zoom logo are trademarks of Zoom Video Communications, Inc).

Various embodiments of the present invention address these shortcomings, while enabling the presenter to maintain one set of presentation slides with intra-slide versioning capability. The different intra-slide versions can be shared automatically during the presentation, based on individual audience profiles. Therefore, audience participants can see different versions of the shared presentation in real time, based on their role, or other defined category. This also allows the presenter to store multiple versions for future use with different audiences in the same presentation. Finally, if the audience participant opts into the feature, location and time zone information can be shown in the web meeting at “all attendance view.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

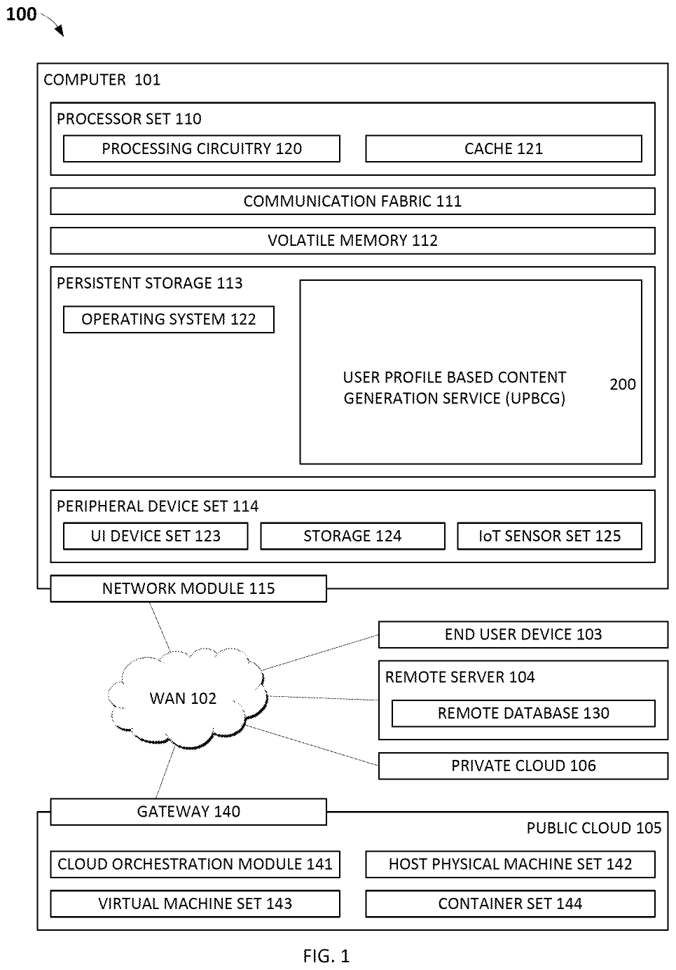

Beginning now with FIG. 1, an illustration is presented of the operating environment of a networked computer, according to an embodiment of the present invention.

Computing environment 100 contains an example of an environment for the execution of at least some of the computer code involved in performing the inventive methods, such as a user profile-based content generation service (UPBCG) (architecture) 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node through WAN 102. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

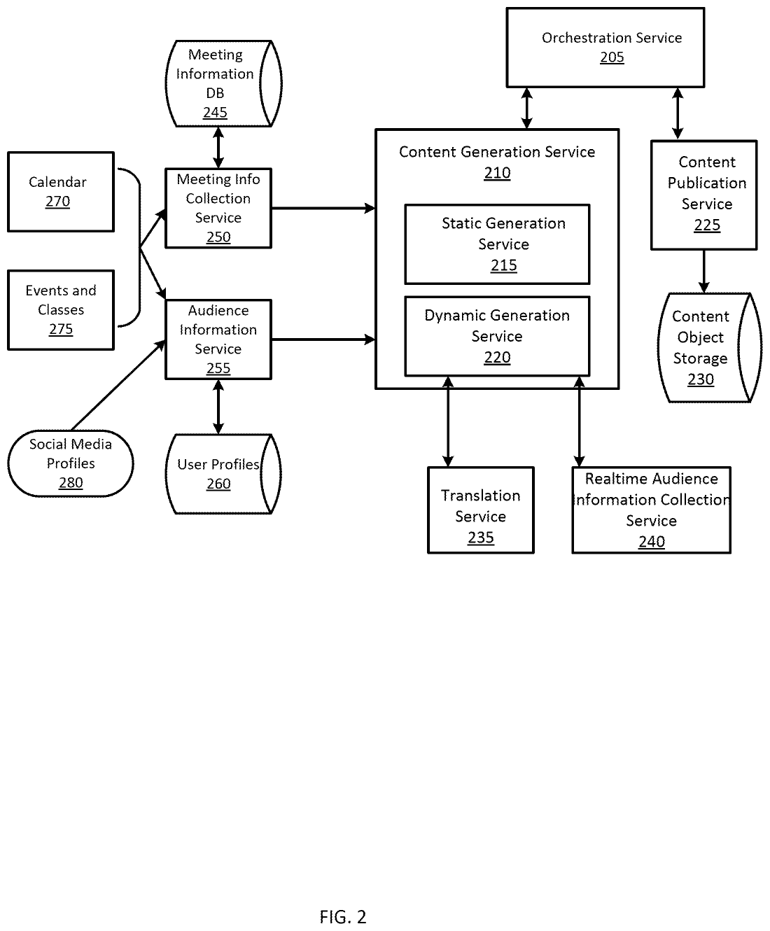

FIG. 2 illustrates components of an exemplary UPBCG architecture 200.

As shown, the UPBCG architecture 200 includes several microservices. The meeting information collection service 250 accesses the meeting information source, such as meeting owner's calendar 270, and a manager of events and classes 275, such as the IBM Event Manager component of IBM InfoSphere Identity Insight® through APIs (IBM Infosphere Identity Insight is a registered trademark of IBM in the United States). Meeting information data that can be updated in the meeting information database 245 includes meeting registrants or invitees, the meeting agenda, and any summary goals of the meeting.

The inputs to the audience information service 255 includes the audience list, as received from the meeting information collection service 250. The audience information service 255 adds a new profile to the user profile database 260 for first-time attendees, and updates existing attendee profiles with new or changed information, such as job role and company. Various social media data profiles 280, such as from LinkedIn, Facebook, and a company's internal directory may be explored for attendee profile data. To ensure privacy, an attendee opts in to participate in this feature. From this profile information, the audience information service 255 can assign a tag to an attendee that represents the attendee's job role (e.g., CxO, technical, SME) and knowledge domain (e.g., cloud, hardware, AI).

The real-time audience information collection service 240 collects data that is not saved in the databases but is used during the meeting. For example, the location of the audience for an in-person meeting, or an attendees' IP/GPS location if that data is enabled (e.g., if the attendee opts into share this data). The location data can be used to customize displayed data based on the attendee's local time, for example, to set the background to day or night style.

The content generation service 210 receives as input a single original presentation deck (parent). One or more child versions is generated of one or more of the slides depending on the attendee profiles. The child versions can be generated in two ways.

The static generation service 215 is usually performed prior to the meeting. The presenter receives the generated contents prior to sharing during the meeting. The parent presentation may include a mix of materials that are appropriate for several different levels of attendees, e.g., technical details vs. marketing details. The static generation service 215 can label selected slides of the parent presentation, or selected portions of a slide (e.g., a figure, table, or paragraph) with the presenter-defined tag associated with a selected role (e.g., CxO, Technical, Sales). Tags can also be defined and associated with security levels (e.g., Confidential, Medium, Non-Confidential). The static generation service 215 makes the associations using a predefined file of customizations that may be stored in the content object storage 230. Additionally, an AI model can be used that is trained on how to evaluate the contents of a slide and associate the slide with a pre-defined tab.

The content generation service 210 uses APIs to receive meeting and audience information from the meeting information collection service 250 and the audience information service 255. The parent presentation and each tagged child version are assembled into presentation decks based on the audience profiles. For example, a parent version may be titled “Worker Insights.” Various child versions may be titled “Worker Insights—for CxO,” “Worker Insights—for Developer,” and so forth, based on the tag associated with the target attendee segment of the audience. Following their generation, the content generation service 210 sends the child versions to the presenter.

The dynamic generation service 220 is usually performed at the start of the meeting. Here, child versions for different languages may be generated, and day/night backgrounds can be generated based on the time zones of the attendees. Following such customizations, the child versions are saved into the content object storage 230, and are identified, for example by author, time, meeting title, etc.

The translation service 235 cooperates with the content generation service 210 to receive the designation of the language(s) of the attendees and the child versions that are tagged as associated with the attendees. If language translation is needed, various existing translation tools are then applied to the child versions, and the translated child versions are output.

The content publication service 225 shares the presentation contents with the attendees. Each attendee is identified by a unique identifier, such as a key associate with the attendee's record in the meeting information database 245. Using the unique identifier, the corresponding presentation version can be retrieved from the content object storage 230, and shared through a channel, as specified in the attendee's user profile 260, such as an email. Additionally, the presentation contents can be posted to a selected website or event management tool.

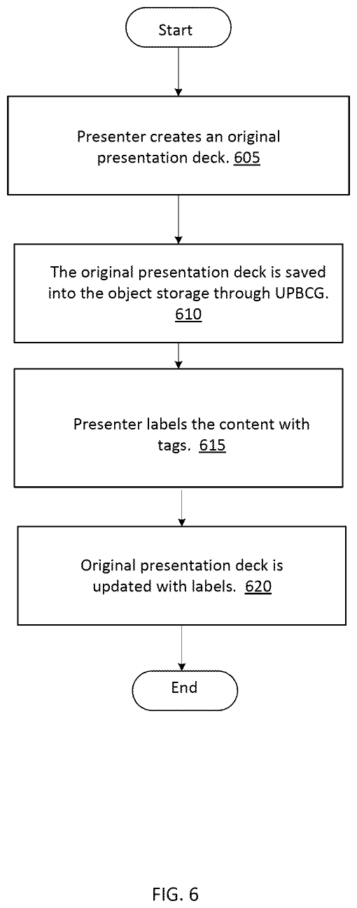

The orchestration service 205 is a control unit that controls the data flow, as described with reference to FIGS. 6-9.

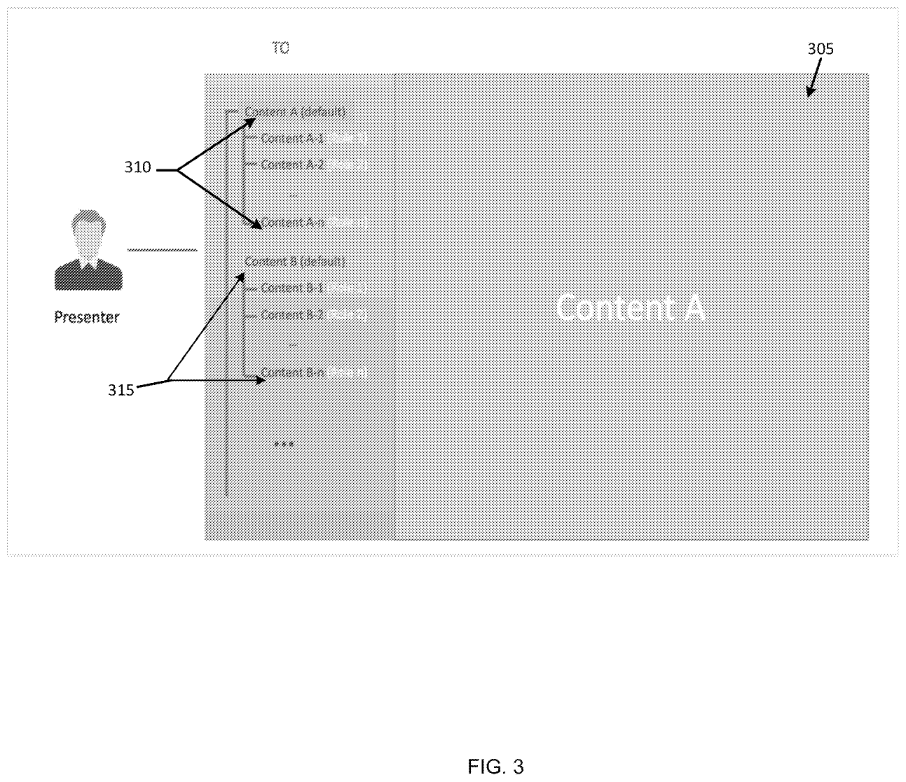

FIG. 3 illustrates a presenter's console in managing/editing mode.

As shown, two different default presentations, Content A 310 and Content B 315 are available for editing. Each presentation includes several customizations, Content A-1 thru Content A-n, and Content B-1 thru Content-Bn, each based on job role. The presentation files are stored in the content object storage 230, along with such metadata as mapping information to link the default presentation to the several child versions.

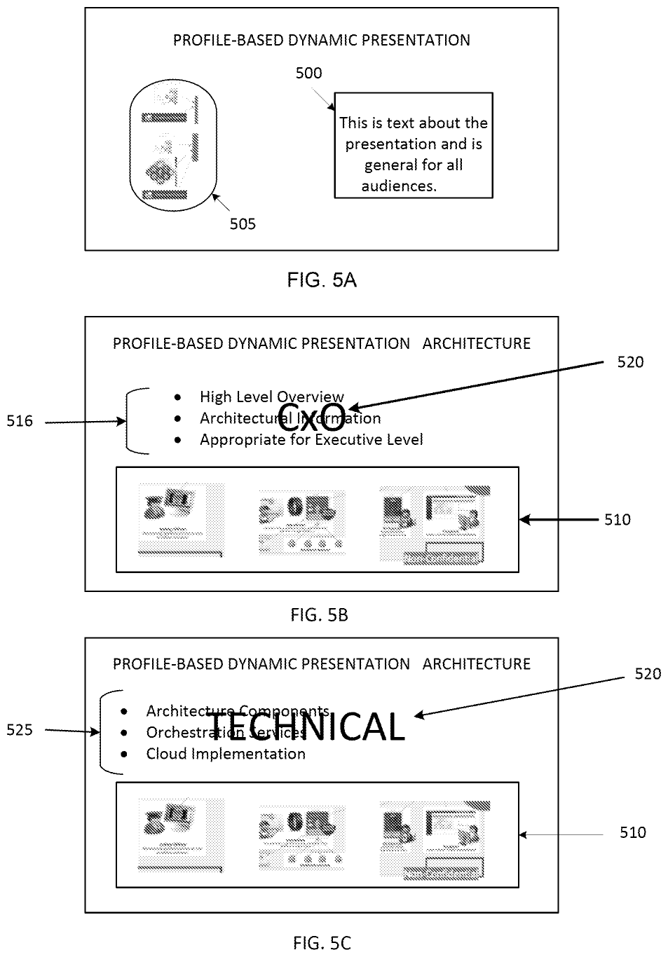

The presenter may start with a generic version of the presentation, the parent version. As an example, FIG. 5A shows a generic page having content 505 and 500 that are associated with all attendees. Content can then be customized for different audiences. For example, for presentation Content A 310, the presenter may generate a page for Content A-1 for Role 1, and a page for Content A-2 for Role 2. The customization includes selecting portions (or all) of the generic page and assigning labels to those portions based on the role of the attendee. The contents for each labeled (tagged) area is updated to suit the target attendee's role. For example, as shown in FIGS. 5B and 5C, generic content 510 exists unchanged in the parent Content A. In child versions Content A-1 and Content A-2, the content in area 516 is customized and labelled (520) for the role CxO. Similarly, the content in area 525 is customized for and labelled (520) for the role TECHNICAL. The areas 516 and 525 are stored in the content object storage 230 as overlays to the parent version and are linked to their parent presentation through stored metadata. Animation can be added by defining a click sequence for each area. For example, on a first click, the CxO tagged content and the TECHNICAL tagged content overlays the generic content. On the second click, the CxO tagged content overlay is removed, and a third click removes the TECHNICAL tagged content overlay.

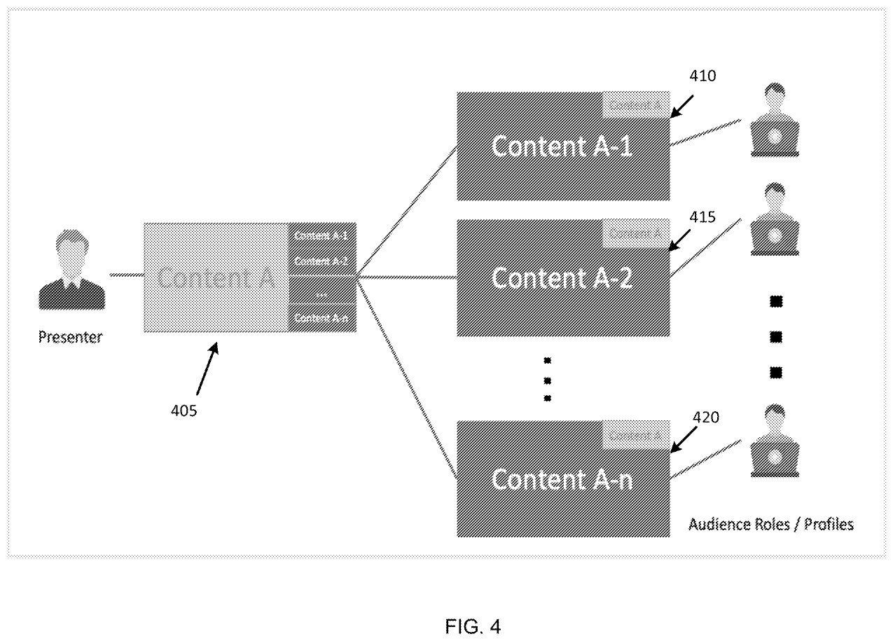

FIG. 4 is an exemplary depiction of the presenter's view (405). The presenter can select between the generic presentation and any of the child versions. Each attendee sees the child version tagged for that attendee's role (410, 415, 420), but each attendee can toggle between the child version and the generic presentation.

FIGS. 6-9 illustrate process flows of the orchestration service 205. FIG. 6 is an exemplary flow of a process for generating original content.

At 605, the presenter creates an original generic presentation. At 610, the original presentation is saved in content object storage 230 of the UPBCG. At 615, the presenter labels the content with tags according to the various roles of the attendees and updates the content object storage 230 with the original presentation and the related child version overlays (620).

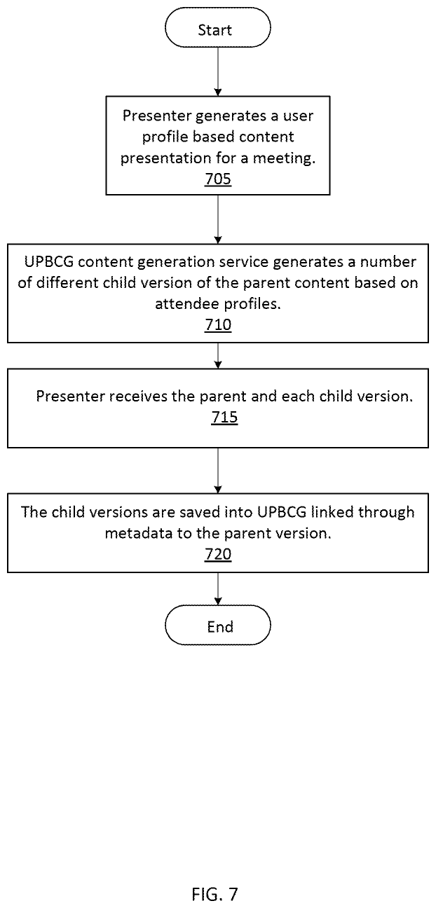

FIG. 7 illustrates a process flow of a static generation service for static generation of child versions. Static generation may be performed prior to the meeting and may include use of a trained AI model.

At 705 the presenter generates a user profile-based content presentation for a meeting. The content is created or selected from existing material in the UPBCG based on profiles of the attendees that are selected or created as described with reference to FIG. 2.

At 710, the presenter invokes the UPBCG content generation service to generate one or more child versions of the parent presentation, as described in FIG. 6.

At 715, the presenter receives the parent and each generated child version.

At 720, all approved child versions are saved into the UPBCG storage.

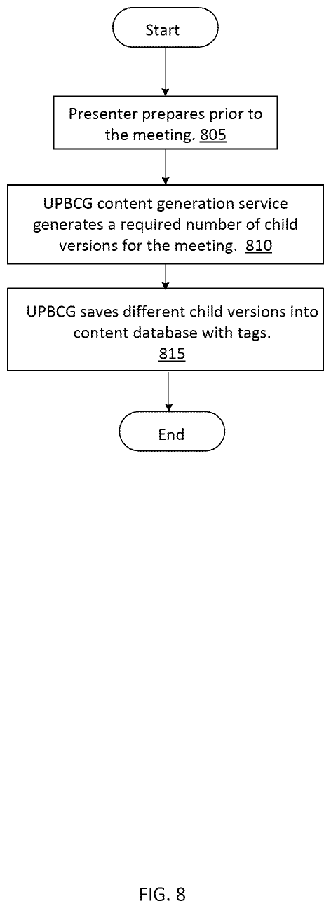

FIG. 8 illustrates a process flow of a dynamic generation service for dynamic generation of child versions. This service differs from the static generation service 215 in that the static generation service 215 is performed to generate the parent and several child versions. The static generation service 215 may be performed using a trained AI mode. Also, the meeting and attendee information that is associated with the meeting is either retrievable from the UPBCG or can be created as in FIG. 6. The dynamic generation service 210 may also be performed prior to the start of the meeting (805). However, while assembling the final presentation versions, the dynamic generation service 210 queries the UPBCG to determine if the attendee list has changed and therefore makes the required updates or additions.

At 810, the dynamic generation service 210 generates the different child versions required for the immediately upcoming meeting. Various factors in the profiles of the attendees can be queried and used to customize each associated child version. Customizations include language translations, dates/times based on an attendee location, and day/night display settings based on GPS settings.

At 815, the various child versions are saved to the UPBCG for later recall, including the associated tags.

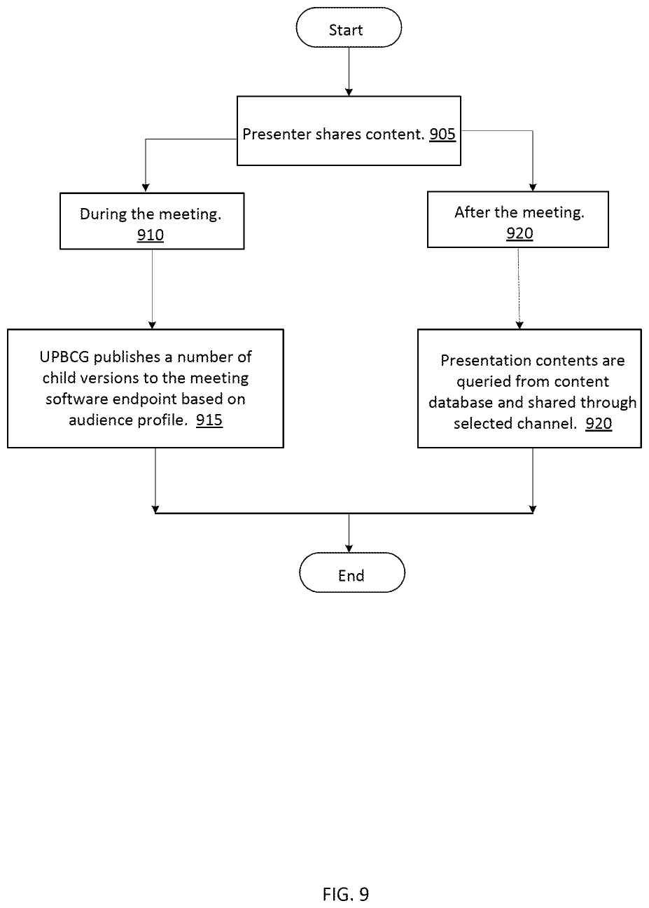

FIG. 9 illustrates a process flow for publishing content during an online meeting.

At 905, the presenter starts the meeting and begins sharing content.

During the meeting, the UPBCG publishes the child versions, according to the role of each of the attendees in the meeting, to each attendee's endpoint. The endpoint can refer to the IP address that was added to the attendee's profile when the attendee registered for the meeting (910, 915).

After the meeting (920), the content publication service 225 publishes the attendee's customized child version through the channel registered in the attendee's profile. The channel includes the attendee's email address, a personal website, or social media website.

What is claimed is:

1. A method, comprising:
receiving at a content generation service, a request to generate a presentation for an online meeting having attendees comprising different roles;
receiving at the content generation service, content for a generic presentation;
defining one or more portion of a page or an entire page of the generic presentation as customizable;
assigning labels to each of the customizable portions of the generic presentation, wherein each label is associated with a role of an attendee in the online meeting;
receiving customized content for each customizable portion, wherein the customized content is associated with the label of the customizable portion; and
storing the generated presentation and each associated customized content separately in content object storage.

2. The method of claim 1, wherein the customized content is selected from the content object storage based on the role of the attendee.

3. The method of claim 1, wherein the presenter toggles between the generated presentation and any of the customized contents on a presenter's display during the online meeting.

4. The method of claim 1, wherein the customized content is an overlay to the generated presentation, and wherein a combination of the customized content and the generated presentation is displayed to each attendee based on attendee role during the online meeting.

5. The method of claim 1, wherein the attendee toggles between the generated presentation and the customized content during the online meeting.

6. The method of claim 1, wherein upon registering for the online meeting, an audience information service stores attendee information, including attendee role.

7. The method of claim 1, wherein a link in the content object storage associates the generated presentation with each customized content based on role.

8. A computer program product, the computer program product comprising a non-transitory tangible storage device having program code embodied therewith, the program code executable by a processor of a computer to perform a method, the method comprising:
receiving at a content generation service, a request to generate a presentation for an online meeting having attendees comprising different roles;
receiving at the content generation service, content for a generic presentation;
defining one or more portion of a page or an entire page of the generic presentation as customizable;
assigning labels to each of the customizable portions of the generic presentation, wherein each label is associated with a role of an attendee in the online meeting;
receiving customized content for each customizable portion, wherein the customized content is associated with the label of the customizable portion; and
storing the generated presentation and each associated customized content separately in content object storage.

9. The computer program product of claim 8, wherein the customized content is selected from the content object storage based on the role of the attendee.

10. The computer program product of claim 8, wherein the presenter toggles between the generated presentation and any of the customized contents on a presenter's display during the online meeting.

11. The computer program product of claim 8, wherein the customized content is an overlay to the generated presentation, and wherein a combination of the customized content and the generated presentation is displayed to each attendee based on attendee role during the online meeting.

12. The computer program product of claim 8, wherein the attendee toggles between the generated presentation and the customized content during the online meeting.

13. The computer program product of claim 8, wherein upon registering for the online meeting, an audience information service stores attendee information, including attendee role.

14. The computer program product of claim 8, wherein a link in the content object storage associates the generated presentation with each customized content based on role.

15. A computer system, comprising:
one or more processors;
a memory coupled to at least one of the processors;
a set of computer program instructions stored in the memory and executed by at least one of the processors in order to perform actions of:
receiving at a content generation service, a request to generate a presentation for an online meeting having attendees comprising different roles;
receiving at the content generation service, content for a generic presentation;
defining one or more portion of a page or an entire page of the generic presentation as customizable;
assigning labels to each of the customizable portions of the generic presentation, wherein each label is associated with a role of an attendee in the online meeting;
receiving customized content for each customizable portion, wherein the customized content is associated with the label of the customizable portion; and
storing the generated presentation and each associated customized content separately in content object storage, wherein a link in the content object storage associates the generated presentation with each customized content based on role.

16. The computer system of claim 15, wherein the customized content is selected from the content object storage based on the role of the attendee.

17. The computer system of claim 15, wherein the presenter toggles between the generated presentation and any of the customized contents on a presenter's display during the online meeting.

18. The computer system of claim 15, wherein the customized content is an overlay to the generated presentation, and wherein a combination of the customized content and the generated presentation is displayed to each attendee based on attendee role during the online meeting.

19. The computer system of claim 15, wherein the attendee toggles between the generated presentation and the customized content during the online meeting.

20. The computer system of claim 15, wherein upon registering for the online meeting, an audience information service stores attendee information, including attendee role.
